(19) United States
(12) Patent Application Publication
(10) Pub. No.: US 2013/0258278 A1
(43) Pub. Date: Oct. 3, 2013

(54) LENS COMPRISING A POLYMERIC SUBSTRATE, A HARDENING LAYER AND A METALLIC LAYER

(71) Applicants: Franco RIGATO, Barcelona (ES); Pau ARTÚS COLOMER, Sant Cugat del Valles (ES); Antoni VILAJOANA MAS, Mataro (ES); Juan Carlos DÜRSTELER LÓPEZ, Castelldefels (ES)

(72) Inventors: Franco RIGATO, Barcelona (ES); Pau ARTÚS COLOMER, Sant Cugat del Valles (ES); Antoni VILAJOANA MAS, Mataro (ES); Juan Carlos DÜRSTELER LÓPEZ, Castelldefels (ES)

(73) Assignee: INDO INTERNACIONAL S.A., Barcelona (ES)

(21) Appl. No.: 13/494,439

(22) Filed: Jun. 12, 2012

(30) Foreign Application Priority Data
Mar. 30, 2012 (ES) P201230484

(51) Int. Cl. G02C 7/02

(52) U.S. Cl. 351/159.57

(57) ABSTRACT

Lens comprising a polymeric substrate, a hardening layer and a metallic layer. Lens comprising a substrate of polymeric material (P), and which is coated with a hardening layer (E) and a metallic layer (M) that is between 1 and 20 nm thick. The coating also has an anti-humidity layer (AH) made of a material from the group made up of ZrO₂, Nb₂O₃, Ta₂O₅, CeO₂, HfO₂, La₂O₃, TiO₂, Pr₂O₃, Sc₂O₃, WO₃, Y₂O₃, ZnS and the combinations thereof, that is between 35 nm and 55 nm thick, where between the anti-humidity layer (AH) and the hardening layer (E) there is no other sandwiched layer that is thicker than or equivalent to the anti-humidity layer (AH). Over the metallic layer (M) there is a first high refraction index layer (A1), and a first low refraction index layer (B1).

### FIELD OF THE INVENTION

The invention relates to a lens comprising a substrate of polymeric material, and it is coated with a hardening layer, which is coated again with a metallic layer on at least one of its surfaces, where the metallic layer is of a metal from the group made up of Cu, Ag, Al, Au, Ni, Ti, Cr, Mo, Pt, Rh, Zr and mixtures thereof, and has a thickness between 1 and 20 nm.

### STATE OF THE ART

Lens coating is well known, and particularly ophthalmic lenses, of a polymeric or organic nature, with hardening layers to improve the abrasion resistance thereof. This coating method is done because the scratch resistance of this type of polymeric lenses is much less than that of mineral lenses. This hardening coating (lacquer) is applied usually by dipping in a (poly)siloxanic, acrylic, metacrylic or polyurethane bath and then setting in an oven at a temperature between 100° C. and 130° C. By means of this method hardening layers are obtained between 1 micron and 3 microns thick. Another possible technique for carrying out the hardening coating is by applying lacquers using the spinning technique with similar mechanical characteristics as above, but with a productive process that only coats one face of the lens in each stage.

On the other hand, it is known to apply anti-reflection (AR) treatments to reduce reflection. To obtain this anti-reflection effect to visible light, usually several layers (typically between 1 and 6) are stacked, each between 10 nm and 150 nm thick. This is usually done using PVD (Physical Vapour Deposition) techniques using an electron gun or thermal evaporation, although other techniques also exist such as Plasma enhanced Chemical Vapour Deposition (PeCVD) or Sputtering.

Furthermore polymeric base lenses are known that include an infra-red filter. In some cases the infra-red filter is obtained by including absorbent pigments in the polymeric basis, typically polycarbonate. However, this limits the available materials and prevents choosing those materials that are optimum for ophthalmic lenses.

Document ES P201130066 describes an ophthalmic and/or solar lens comprising a substrate of polymeric material and which is coated with a hardening layer. On at least one of its surfaces it is coated with a metallic layer, which preferably is Ag. The thickness of the metallic layer is between 1 and 20 nm, and the visible reflection of the lens is less than 10%. The manufacturing method comprises a depositing stage, via the physical deposition of vapour with evaporation via an electron gun, of the metallic layer. Between the metallic layer and the hardening layer there can be a layer of SiO₂. Also there can be a layer of SiO₂ on top of the metallic layer. Also the possibility of including high refraction index layers is described, between the layers of SiO₂ and the metallic layer. However, on the lenses manufactured according to the method described in document ES P201130066, surface defects (small surface wrinkles) can appear, which are visible to users and have a negative optical and/or aesthetic effect.

In this description and claims, it is to be understood that the term “lens” refers to any optical system made up of at least one surface and which has dioptric and/or catoptric properties. In other words, any optical system based on refraction phenomena (dioptric systems), such as for example ophthalmic lenses, and on reflection phenomena (catoptric systems), such as for example optical mirrors. Also those optical systems that combine both effects must be considered as lenses, such as for example optical systems with a first refractive surface and a second reflective surface, optical systems with semitransparent surfaces, etc.

### DISCLOSURE OF THE INVENTION

The aim of the invention is to overcome these drawbacks. This aim is achieved by means of a lens of the type indicated at the beginning, characterized in that it has an anti-humidity layer made of a material from the group made up of ZrO₂, Nb₂O₃, Ta₂O₅, CeO₂, HfO₂, La₂O₃, TiO₂, Pr₂O₃, Sc₂O₃, WO₃, Y₂O₃, ZnS and combinations thereof, preferably of the group made up of Nb₂O₅, ZrO₂ and Ta₂O₅, which is between 35 nm and 55 nm thick,

where between the anti-humidity layer and the hardening layer there is no other sandwiched layer with a thickness greater or equivalent to that of the anti-humidity layer,

and characterized in that over the metallic layer there is a first layer of high refraction index, which is less than 100 nm, preferably between 30 and 65 nm, and over the first high refraction index layer there is a first low refraction index layer, which is less than 120 nm thick, preferably between 75 and 105 nm.

In fact, probably the cause of the formation of the surface defects (or one of the causes) is the absorption of ambient humidity. The effect observed consists of deformations in the structure of the layers that is probably due to humidity absorption. It has been observed that, including an anti-humidity layer made from a material from the group made up of ZrO₂, Nb₂O₃, Ta₂O₅, CeO₂, HfO₂, La₂O₃, TiO₂, Pr₂O₃, Sc₂O₃, WO₃, Y₂O₃, ZnS and the combinations thereof and between 35 nm and 55 nm thick is sufficient to prevent said surface defects from appearing. This layer must be “near” the hardening layer as it is the hardening layer that seems to suffer from the effect of humidity absorption or, at least, the consequences arising from it. Therefore, between the anti-humidity layer and the hardening layer there must not be another layer or set of layers with a thickness greater than that of the actual anti-humidity layer, as that causes it to be less effective. In particular it is convenient that there be no layer of silicon oxide or, in general, any layer of low refraction index materials. Probably it was precisely the presence of low refraction index layers sandwiched between the hardening layer and the high refraction index layer that caused the presence of surface defects in the lenses made according to document ES P201130066. However, the lens according to the invention could include low refraction index layers (for example, of SiO₂) on top of the anti-humidity layer, that is, between the anti-humidity layer and the metallic layer. Furthermore, it is possible that it is convenient to include a layer sandwiched between the anti-humidity layer and the hardening layer for other reasons, such as for example a layer to promote adherence. According to the invention, it is possible to include a layer between the anti-humidity layer and the hardening layer providing that this sandwiched layer is thinner than the anti-humidity layer.

However, by modifying the structure of layers between the metallic layer and the hardening layer, it is necessary to include on top of the metallic layer a first high refraction index layer and a first low refraction index layer with the specified thicknesses.

In this description and claims, the term “anti-humidity layer” has been used to designate the layer of materials from the group made up of ZrO₂, Nb₂O₃, Ta₂O₅, CeO₂, HfO₂, La₂O₃, TiO₂, Pr₂O₃, Sc₂O₃, WO₃, Y₂O₃, ZnS and the combinations thereof, arranged between the metallic layer and the hardening layer. However it must be understood that it is called an “anti-humidity” layer simply because it has been supposed that the effect caused is to interrupt the effects of absorbing ambient humidity. It must be understood that this invention covers both the case where the physical phenomenon is effectively interrupting the absorption of humidity, and any other effect attributable to the inclusion of this layer in the conditions claimed.

The lenses according to the invention can be both transparent in the visible spectrum (lenses for inside) and solar lenses, and have the following properties:
Transmittance in the IR_{A} (from 750 nm to 1400 nm) 50%
Transmittance in the IR_{A+B} (from 750 nm to 3000 nm) 50%
Anti-reflective in the visible spectrum (380-780 nm). Reflection <2.5%
Visible transmittance between 100% and 5%

Preferably the metallic layer is made of a metal from the group made up of Cu, Ag, Cr, Al, Au y Ni, and very preferably of Ag. Advantageously this metallic layer is between 5 and 15 nm thick.

Preferably over the first low refraction index layer there is a second high refraction index layer, which is less than 120 nm thick, preferably between 75 and 105 nm, and over the second high refraction index layer there is a second low refraction index layer, which is less than 100 nm thick, preferably between 55 and 80 nm. In fact, this ensures that the unit has an anti-reflective effect within the visible light spectrum. However, if a lens is desired with a certain mirror effect, these second layers could be omitted or the thicknesses of all these layers could be modified to obtain a mirror effect.

Advantageously at least one of the first and second high refraction index layers is made of a material from the group made up of oxides, nitrides or oxynitrides of Zr, Ti, Sb, In, Sn, Ce, Zn, Ta, Nb, Hf and mixtures thereof, preferably ZrO₂. For its part, at least one of the first and second low refraction index layers is preferably made of SiO₂.

Between the anti-humidity layer and the metallic layer and/or between the first high refraction index layer and the metallic layer there is, advantageously, an interface layer made of a material from the group made up of Si, Cr, Ti, Ni, Ni/Cr, SnO₂, Al₂O₃, AlN, ZnO, SiOₓ, SiO/Cr, SiO₂/Al₂O₃, ITO, and MoO₃. This interface layer is preferably less than 10 nm thick, and very preferably between 1 and 4 nm thick.

The structure of layers can comprise, additionally an initial interface layer between the interface layer and the anti-humidity layer. The initial interface layer is made of a material from the group made up of Si, Cr, Ti, Ni, Ni/Cr, SnO₂, Al₂O₃, AlN, ZnO, SiOₓ, SiO/Cr, SiO₂/Al₂O₃, ITO, and MoO₃, and it is less than 20 nm thick, preferably between 4 and 15 nm thick.

Advantageously the lens comprises a priming layer between the substrate and the hardening layer.

A preferred embodiment of the invention is obtained with a lens comprising the following structure of layers over the hardening layer:
[a] an anti-humidity layer made of ZrO₂ between 35 and 55 nm thick,
[b] an initial interface layer made of ITO between 4 and 10 nm thick,
[c] an interface layer made of Cr between 2 and 5 nm thick,
[d] a metallic layer made of Ag, between 3 and 9 nm thick,
[e] an interface layer made of Cr between 2 and 5 nm thick,
[f] a first high refraction index layer, made of ZrO₂, between 40 and 60 nm thick,
[g] a first low refraction index layer, made of SiO₂, between 80 and 100 nm thick,
[h] a second high refraction index layer, made of ZrO₂, between 85 and 110 nm thick,
[i] a second low refraction index layer, made of SiO₂, between 55 and 75 nm thick.

Preferably the lens is an ophthalmic and/or solar lens.

### BRIEF DESCRIPTION OF THE DRAWINGS

Other advantages and characteristics of the invention can be appreciated from the following description, which describes, in a non-limiting way, preferred embodiments of the invention, with reference to the accompanying drawings, in which:

FIG. 1, a schematic cross section view of an embodiment of a lens according to the invention.

FIG. 2, a schematic cross section view of a solar infra-red filter coating according to the invention.

FIG. 3, a schematic cross section view of another solar infra-red coating according to the invention.

### DETAILED DESCRIPTION OF EMBODIMENTS OF THE INVENTION

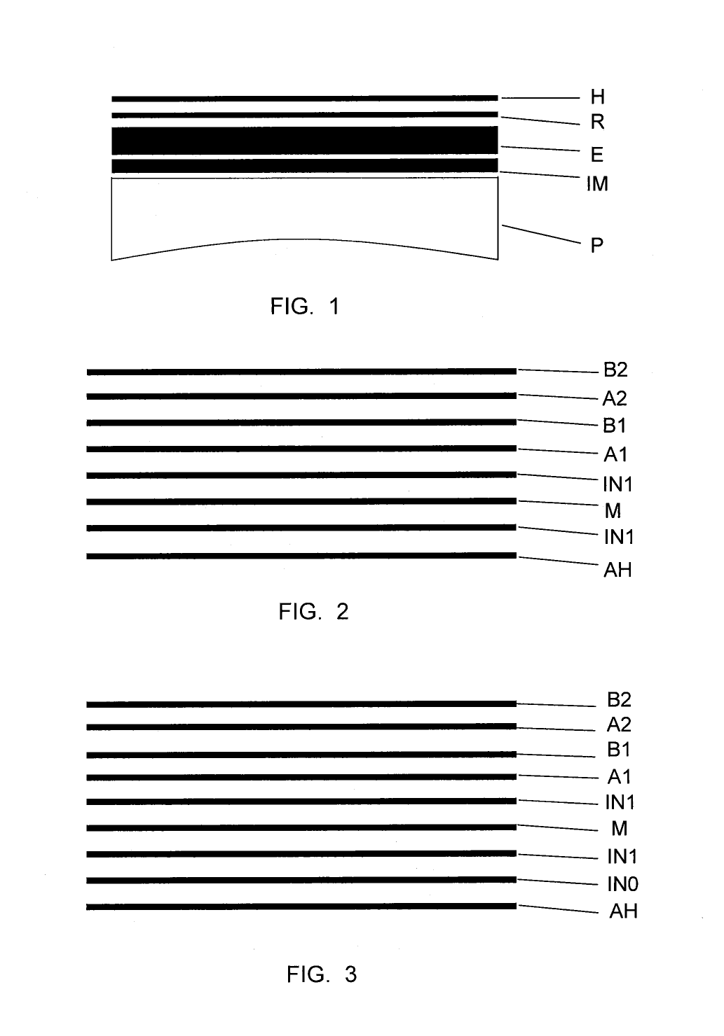

FIG. 1 shows an example of the general structure of the lens according to the invention. The lens comprises a base P of polymeric material over which there is a priming layer IM, which is optional and which is usually between 0.3 and 1.5 microns thick. Then there is a hardening layer E (usually between 1 and 4 microns thick) over which there lies the coating R which acts as the solar infra-red filter. This coating R is made up of a series of layers so that the unit also has other properties, such as anti-reflective properties to visible light, anti-electrostatic properties and mechanical and anti-ageing properties appropriate to meet the various standards. The unit of the coating R is usually between 50 nm and 690 nm thick. The last layer in the structure is a hydrophobic layer H, between 3 and 25 nm thick. Generally, this structure can be present on the two surfaces of the lens or just on one of them. If on just one of them, a conventional anti-reflection coating can be applied to the opposite surface to reduce reflections and increase the transparency of visible radiation.

FIG. 2 shows the detail of an embodiment according to the invention of coating R. The coating R has a first anti-humidity layer AH over which there is an interface layer IN1, the metallic layer M, another interface layer IN1, a first high refraction index layer A1, a first low refraction index layer B1, a second high refraction index layer A2 and a second low refraction index layer B2.

The layers of high and low refraction index A1, A2, B1 and B2 allow adjusting the optical properties and obtaining good scratch resistance mechanical properties. For their part, the interfaces IN1 have less effect on the optical properties but they improve the adherence, wear and tear and barrier properties against oxidation and against the metal diffusion of the metallic layer M. In certain cases these interface layers IN1 can be made up of two sub-layers. For its part, the metallic layer M has a major effect on the optical properties in the visible spectrum, and it is the main layer responsible for the solar infra-red filter effect (by reflecting the radiation of the solar to infra-red spectrum). As already mentioned the anti-humidity layer AH is the one that prevents the unit of layers from deforming, presumably because of the change in volume of the whole system due to the absorption of water.

FIG. 3 shows an embodiment of a coating R in the particular case of a lens with IR solar filter for a solar lens with a transmittance value in the visible spectrum less than or equivalent to 80%. The general structure of the lens is similar to that in FIG. 1, but, in this case, the structure does not have a first priming layer IM. The hardening layer E is between 1.6 and 2.7 microns, and the hydrophobic layer H is between 12 and 20 nm. The coating has a first anti-humidity layer AH made of ZrO₂ that is 45 nm thick over which there is an initial interface layer IN0 made of ITO that is 5 nm thick. Over the initial interface layer IN0 there is an interface layer IN1 made of Cr that is 3.5 nm thick. Then there is the metallic layer M, made of Ag that is 6.1 nm thick over which there is another interface layer IN1 also made of Cr and which is 3.5 nm thick. Over this interface layer IN1 there is a first high refraction index layer Al made of ZrO₂, that is 49 nm thick, a first low refraction index layer B1, made of SiO₂, that is 90 nm thick, a second high refraction index layer A2, also made of ZrO₂ that is 93 nm thick and, finally, there is a second low refraction index layer made of SiO₂ that is 67 nanometres thick.

All these layers are obtained by means of the PVD (Physical Vapor Deposition) technique, which evaporates the solid materials (SiO₂, ZrO₂, Cr, Ag and ITO) directly, using an electron gun to make them evaporate.

1.-14. (canceled)

15. Lens comprising:
a substrate of a polymeric material, and which is coated with a hardening layer, which is coated with a metallic layer on at least one surface thereof,
wherein said metallic layer is a metal selected from the group consisting of Cu, Ag, Al, Au, Ni, Ti, Cr, Mo, Pt, Rh, and Zr or mixtures thereof, and is between 1 and 20 nm thick;
an anti-humidity layer made of a material selected from the group consisting of Nb₂O₅, ZrO2, Nb₂O₃, Ta₂O₅, CeO₂, HfO₂, La₂O₃, TiO₂, Pr₂O₃, Sc₂O₃, WO₃, Y₂O₃, and ZnS or mixtures thereof, which is between 35 nm and 55 nm thick,
wherein between said anti-humidity layer and said hardening layer there is no other sandwiched layer with a thickness greater or equivalent to that of the anti-humidity layer; and
over said metallic layer there is a first high refraction index layer, which is less than 100 nm thick, and over said first high refraction index layer there is a first low refraction index layer, which is less than 120 nm thick.

16. Lens according to claim 15 wherein said anti-humidity layer is made of Nb₂O₅, ZrO₂ or Ta₂O₅.

17. Lens according to one of claims 15, wherein between said anti-humidity layer and said hardening layer there is a sandwiched layer that is thinner than said anti-humidity layer.

18. Lens according to claim 15, wherein said metallic layer is made of Cu, Ag, Cr, Al, Au or Ni.

19. Lens according to claim 15, wherein said metallic layer is between 5 and 15 nm thick.

20. Lens according to claim 15, wherein over said first low refraction index layer there is a second high refraction index layer, which is less than 120 nm thick, and over said second high refraction index layer there is a second low refraction index layer, which is less than 100 nm thick.

21. Lens according to claim 15, wherein at least one of said first and second high refraction index layers is made of a material selected from the group consisting of oxides, nitrides or oxynitrides of Zr, Ti, Sb, In, Sn, Ce, Zn, Ta, Nb, and Hf or mixtures thereof.

22. Lens according to claim 15, wherein at least one of said first and second low refraction index layers is made of SiO₂.

23. Lens according to claim 15, wherein between at least one of said anti-humidity layer and said metallic layer or said first high refraction index layer and said metallic layer there is an interface layer made of a material selected from the group consisting of Si, Cr, Ti, Ni, Ni/Cr, SnO₂, Al₂O₃, AlN, ZnO, SiOₓ, SiO/Cr, SiO₂/Al₂O₃, ITO, and MoO₃.

24. Lens according to claim 23, wherein said interface layer is less than 10 nm thick.

25. Lens according to claim 23, wherein between said interface layer and said anti-humidity layer there is an initial interface layer, wherein said initial interface layer is made of a material selected from the group consisting of Si, Cr, Ti, Ni, Ni/Cr, SnO₂, Al₂O₃, AlN, ZnO, SiOₓ, SiO/Cr, SiO₂/Al₂O₃, ITO, and MoO₃, where said initial interface layer is less than 20 nm thick.

26. Lens according to claim 15, further comprising a priming layer between said substrate and said hardening layer.

27. Lens according to claim 15, further comprising the following layers over said hardening layer:
an anti-humidity layer made of ZrO₂ between 35 and 55 nm thick,
an initial interface layer made of ITO between 4 and 10 nm thick,
an interface layer made of Cr between 2 and 5 nm thick,
said metallic layer, made of Ag, between 3 and 9 nm thick,
an interface layer made of Cr between 2 and 5 nm thick,
a first high refraction index layer, made of ZrO₂, between 40 and 60 nm thick,
a first low refraction index layer, made of SiO₂, between 80 and 100 nm thick,
a second high refraction index layer, made of ZrO₂, between 85 and 110 nm thick,
a second low refraction index layer, made of SiO₂, between 55 and 75 nm thick.

28. Lens according to claim 15, wherein the lens is an ophthalmic solar lens.

29. Lens according to one of claim 16, wherein between said anti-humidity layer and said hardening layer there is a sandwiched layer that is thinner than said anti-humidity layer.

30. Lens according to claim 24, wherein between said interface layer and said anti-humidity layer there is an initial interface layer, wherein said initial interface layer is made of a material selected from the group consisting of Si, Cr, Ti, Ni, Ni/Cr, SnO₂, Al₂O₃, AlN, ZnO, SiOₓ, SiO/Cr, SiO₂/Al₂O₃, ITO, and MoO₃, where said initial interface layer is less than 20 nm thick.
